(19) United States
(12) Patent Application Publication
(10) Pub. No.: US 2017/0311615 A1
(43) Pub. Date: Nov. 2, 2017

(54) Smoker Box

(71) Applicant: Patrick King, Rosemount, MN (US)

(72) Inventor: Patrick King, Rosemount, MN (US)

(21) Appl. No.: 15/496,238

(22) Filed: Apr. 25, 2017

Related U.S. Application Data
(60) Provisional application No. 62/328,081, filed on Apr. 27, 2016.

(51) Int. Cl. A23B 4/052; A47J 37/07; A23L 5/10

(52) U.S. Cl. CPC A23B 4/052; A23L 5/15; A47J 37/0786

(57) ABSTRACT

A smoker box. The smoker box includes a base, a pair of longitudinally extending sidewalls, a pair of laterally extending sidewalls, and an interior volume. A lid including a pair of wings disposed on opposing sides thereof is removably securable to the smoker box. The pair of wings extend outwardly at an angle with respect to the lid and define a vent opening between an upper edge of the longitudinally extending sidewalls and the planar member. A recessed portion disposed on an upper edge of one of the pair of laterally extending sidewalls includes an upper recess and a lower recess. A tab disposed on a first end of the lid is configured to engage the upper recess such that an opening is defined by a lower edge of the tab and an upper edge of the lower recess.

### CROSS REFERENCE TO RELATED APPLICATIONS

This application claims the benefit of U.S. Provisional Application No. 62/328,081 filed on Apr. 27, 2016. The above identified patent application is herein incorporated by reference in its entirety to provide continuity of disclosure.

### FIELD OF THE INVENTION

The present invention relates to smoker boxes. More specifically, the present invention provides a smoker box that can be placed within an enclosure to prepare food via the application of heat and smoke.

### BACKGROUND OF THE INVENTION

Many individuals prepare food via a method of cooking known as smoking. Smoking food involves directing the heat and smoke of a fuel source into an enclosed chamber that holds the food therein. The combination of the heat and smoke cooks the food, while the smoke imparts a desirable flavor. Different types of fuel impart different flavors to the prepared food, allowing for a wide variety of flavors to be achieved by varying the fuel source.

Devices have been disclosed in the prior art that relate to food smoking devices. These include devices that have been patented and published in patent application publications. However, these devices have several drawbacks. Some of these devices include large standalone smokers. These large units can be prohibitively expensive and difficult to transport. Other devices include smoker boxes that house a fuel source for providing smoke. These smoker boxes can be placed within an enclosure with a food item in order to smoke the food. However, such boxes are unable to provide the necessary heat to facilitate the smoking process. These boxes must be utilized along with a secondary heat source, which is inefficient and costly. In view of the above, it is therefore desirable to provide a smoker box that can be placed within an enclosure, such as a gas grill housing, that provides both sufficient heat and smoke for preparing food items via smoking.

In light of the devices disclosed in the prior art, it is submitted that the present invention substantially diverges in design elements from the prior art and consequently it is clear that there is a need in the art for an improvement to existing food smoking devices. In this regard the present invention substantially fulfills these needs.

### SUMMARY OF THE INVENTION

In view of the foregoing disadvantages inherent in the known types of smoker boxes now present in the prior art, the present invention provides a smoker box wherein the same can be utilized for providing convenience for the user when preparing smoked foods. The smoker box includes a base, a pair of longitudinally extending sidewalls, a pair of laterally extending sidewalls, and an interior volume. A lid including a pair of wings disposed on opposing sides thereof is removably securable to the smoker box. The pair of wings extend outwardly at an angle with respect to the lid and define a vent opening between an upper edge of the longitudinally extending sidewalls and the planar member. A recessed portion disposed on an upper edge of one of the pair of laterally extending sidewalls includes an upper recess and a lower recess. A tab disposed on a first end of the lid is configured to engage the upper recess such that an opening is defined by a lower edge of the tab and an upper edge of the lower recess.

One object of the smoker box is to provide a food smoking device that provides both the necessary amounts of heat and smoke to prepare food.

Another object of the smoker box is to provide a food smoking device that can be placed within the enclosure of a gas grill along with the food to be prepared in order to convert the gas grill into a temporary smoker.

A further object of the smoker box is to provide a food smoking device having upper vent openings and a plurality of sidewall apertures for facilitating airflow, allowing the fuel to produce the required amounts of heat and smoke.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the smoker box.

FIG. 2 shows a top down view of the smoker box.

FIG. 3A shows an end view of the smoker box with the lid attached.

FIG. 3B shows an end view of the smoker box with the lid removed.

FIG. 4 shows a side view of the smoker box.

### DETAILED DESCRIPTION OF THE INVENTION

Reference is made herein to the attached drawings. Like reference numerals are used throughout the drawings to depict like or similar elements of the smoker box. For the purposes of presenting a brief and clear description of the present invention, the preferred embodiment will be discussed as used for preparing foods via the simultaneous application of heat and smoke. The figures are intended for representative purposes only and should not be considered to be limiting in any respect.

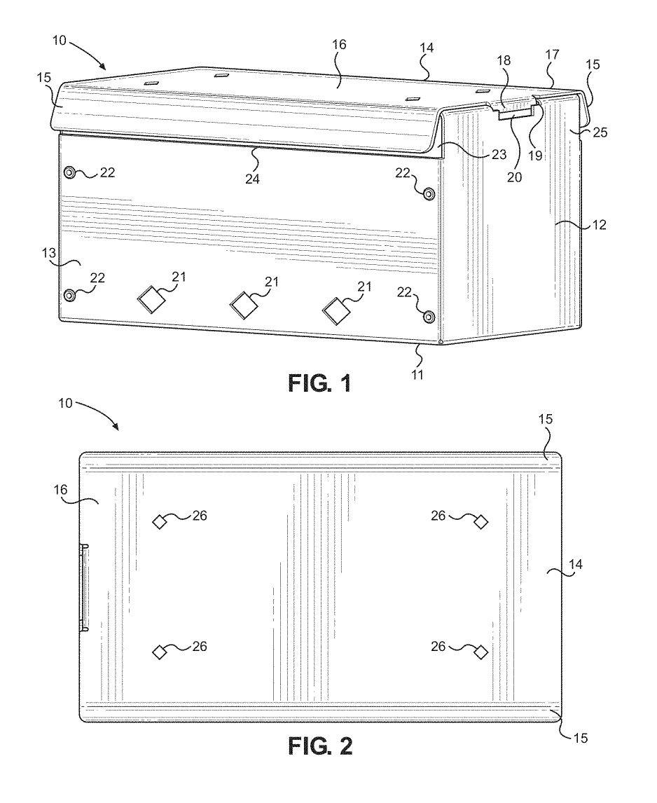

Referring now to FIG. 1, there is shown a perspective view of the smoker box. The smoker box 10 comprises a base 11, a pair of opposing lateral sidewalls 12, and a pair of opposing longitudinal sidewalls 13 defining an interior volume. The interior volume is adapted to receive wood pellets, wood chips, or other combustible material that produces heat and smoke for preparing food. In the illustrated embodiment, the base 11, the pair of longitudinal sidewalls 13, and the pair of lateral sidewalls 12 are unitary in construction which can be formed via stamping a sheet of metal such as aluminum or a similarly durable material. The smoker box 10 can include fasteners 22 such as rivets that secure each longitudinal sidewall 13 to the respective adjacent lateral sidewall 12.

A lid 14 is removably securable to the smoker box 10 and is supported by the lateral sidewalls 12. The lid 14 comprises a planar member 16 having wings 15 disposed on opposing sides thereof. The wings 15 extend downwardly and outwardly at an angle with respect the planar member 16. The angle of each wing 15 with respect to the planar member 16 can be between ninety degrees and one hundred forty degrees. When the lid 14 is secured to the smoker box 10, a vent opening 23 is defined by an upper edge 24 of each longitudinal sidewalls 13 and the planar member 16 of the lid 14. The vent opening 23 facilitates airflow which increases the heat and smoke output of the fuel burning within the interior volume of the smoker box 10.

The lid 14 further includes a tab 18 disposed on a first end 17 thereof. The tab 18 extends downward from the planar member 16 of the lid 14. The tab 18 engages an upper recess 19 disposed on an upper portion 25 of one of the lateral sidewalls 12. When the lid 14 is secured to the smoker box 19, an opening 20 is through which a pair of tongs may be inserted to facilitate hands-free removal of the lid 14.

A plurality of sidewall apertures 21 are disposed on the longitudinal sidewalls 13. The plurality of sidewall apertures 21 allow heated air and smoke to exit the smoker box 10. The plurality of apertures 21 are positioned in a linear arrangement in the illustrated embodiment. However, the plurality of apertures 21 may be positioned anywhere on the longitudinal sidewall, and no claim is made as to their shape or dimension.

Referring now to FIG. 2, there is shown a top down view of the smoker box with the lid attached. The lid 14 further comprises lid apertures 26 disposed on the planar member 16. The lid apertures 26 further facilitate airflow when the lid 14 is secured to the smoker box 10. In the illustrated embodiment, the lid apertures are square in shape and are disposed on corner portions of the planar member 16. However, the number and positioning of the lid apertures 26 may vary. Additionally, the wings 15 extend across the length of the lid 14.

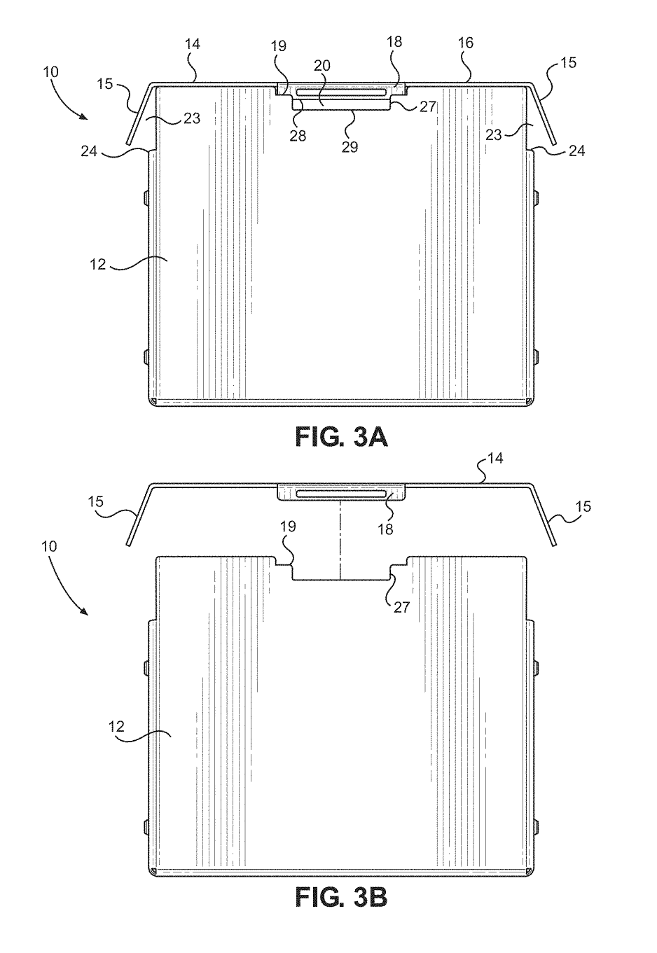

Referring now to FIGS. 3A and 3B, there is shown a side of the smoker box with the lid attached and a side view of the smoker box with the lid removed, respectively. When the lid 14 is secured to the smoker box 10, the vent opening 23 defined by the wings 15 and the longitudinal side upper edge 24 permits airflow to the smoker box 10. The lateral sidewall 12 includes an upper recess 19 and a lower recess 27. The tab 18 extending downward from the planar member 16 of the lid 14 is adapted to engage the upper recess 19, such that an opening 20 is formed between an edge 29 of the lower recess 27 and a lower edge 28 of the tab 18. In the illustrated embodiment, the width of the upper recess 19 is less than the width of the lower recess 27.

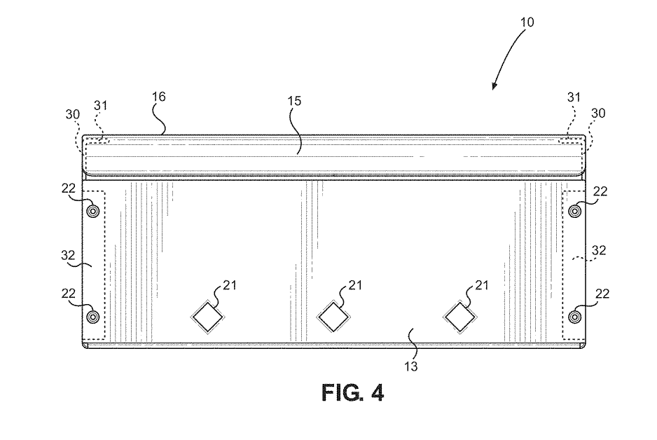

Referring now to FIG. 4, there is shown a side view of the smoker box. The pair of lateral sidewalls 12 comprise an upper portion 30 extending upwardly past the longitudinal sidewalls 13. Each upper portion 30 comprises a horizontal flange 31 extending perpendicularly therefrom. The horizontal flanges 31 support the planar member 16 of the lid thereon, such that the wings 15 extend outwardly from the horizontal flanges 31.

In the illustrated embodiment, the lateral sidewalls further include vertical flanges 32 that facilitate securement of the lateral sidewalls and the longitudinal sidewalls 13. The vertical flanges 32 are fastened to the longitudinal sidewalls 13 via a fastener 22 such as a rivet. This provides structural stability to the smoker box 10.

In use, a fuel source is burned within the interior volume of the smoker box 10, and hot air and smoke are expelled through the plurality of sidewall apertures 21. The smoker box 10 can be placed in an enclosure along with a food item to be prepared. For example, the smoker box 10 may be placed within the enclosure of a typical gas grill such that the food is positioned adjacent to the smoker box 10. The smoker box 10 can be filled with a combustible material that produces smoke and heat when burned, which can include wood, wood chips, wood pellets, or any combination thereof. The heated smoke escapes the smoker box 10 via the sidewall apertures 21, but is kept within the enclosure. In this way, the food within the enclosure can be prepared via the application of heat and smoke provided by the smoker box 10 without the need for an additional heat source.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A smoker box, comprising:
a base;
a pair of longitudinally extending sidewalls;
a pair of laterally extending sidewalls;
an interior volume;
a lid comprising a planar member having a pair of wings disposed on opposing longitudinal sides thereof, each wing of the pair of wings extending downwardly and outwardly at an angle with respect to the planar member;
a tab disposed on a first end of the lid; and
a recessed portion disposed on an upper edge of one of the pair of laterally extending sidewalls, the recessed portion comprising an upper recess and a lower recess, wherein the tab is configured to engage the upper recess such that an opening is defined by a lower edge of the tab and an edge of the lower recess;

2) The smoker box of claim 1, further comprising a plurality of sidewall apertures disposed on the pair of longitudinally extending sidewalls.

3) The smoker box of claim 2, wherein the plurality of sidewall apertures are arranged in a linear arrangement.

4) The smoker box of claim 1, further comprising a plurality of lid apertures disposed on the planar member of the lid.

5) The smoker box of claim 1, wherein the base, the pair of longitudinally extending sidewalls, and the pair of laterally extending sidewalls are unitary in construction.

6) The smoker box of claim 1, further comprising a pair of vent openings, each vent opening defined by an upper edge of one of the longitudinally extending sidewalls and the planar member of the lid.

7) The smoker box of claim 1, wherein the pair of laterally extending sidewalls comprise an upper portion extending from an upper edge of the pair of longitudinal sidewalls, the upper portion comprising a horizontal flange extending perpendicularly therefrom, wherein the horizontal flange supports the lid thereon.

8) The smoker box of claim 1, wherein the angle of each wing of the pair of wings with respect to the planar member is between ninety degrees and one hundred forty degrees.

9) The smoker box of claim 1, wherein the base, the pair of longitudinally extending sidewalls, the pair of laterally extending sidewalls, and the lid are composed of aluminum.
